(19) United States
(12) Patent Application Publication
(10) Pub. No.: US 2023/0085991 A1
(43) Pub. Date: Mar. 23, 2023

(54) ANOMALY DETECTION AND FILTERING OF TIME-SERIES DATA

(71) Applicant: SPARKCOGNITION, INC., AUSTIN, TX (US)

(72) Inventor: ELAD LIEBMAN, AUSTIN, TX (US)

(21) Appl. No.: 17/933,408

(22) Filed: Sep. 19, 2022

Related U.S. Application Data
(60) Provisional application No. 63/245,923, filed on Sep. 19, 2021.

(51) Int. Cl. G05B 23/02

(52) U.S. Cl. CPC G05B 23/0259

(57) ABSTRACT

Anomaly detection and filtering of time-series data, including: identifying, for a multivariate time-series signal, one or more previously observed multivariate time-series signals that are similar within a predetermined threshold to the multivariate time-series signal; and labelling the multivariate time-series signal based on the labels associated with the one or more previously observed multivariate time-series signals.

### CROSS-REFERENCE TO RELATED APPLICATION

This is a non-provisional application for patent entitled to a filing date and claiming the benefit of earlier-filed U.S. Provisional Patent Application No. 63/245,923, filed Sep. 19, 2021, herein incorporated by reference in its entirety.

### BRIEF DESCRIPTION OF DRAWINGS

FIGS. 1A, 1B, and 1C illustrate a particular embodiment of a system that is operable to perform unsupervised model building for clustering and anomaly detection

FIG. 2 is a diagram to illustrate a particular embodiment of neural networks that may be included in the system of FIG. 1A-1C.

FIG. 3 is a diagram to illustrate a particular embodiment of a system that is operable to determine a topology of a neural network, such as a neural network of FIGS. 1A-1C or FIG. 2, based on execution of a genetic algorithm.

FIG. 4 sets forth a flow chart of an example method of anomaly detection and filtering of time-series data in accordance with some examples of the present disclosure.

FIG. 5 sets forth a flow chart of an additional example method of anomaly detection and filtering of time-series data in accordance with some examples of the present disclosure.

FIG. 6 sets forth a flow chart of an additional example method of anomaly detection and filtering of time-series data in accordance with some examples of the present disclosure.

FIG. 7 sets forth a flow chart of an additional example method of anomaly detection and filtering of time-series data in accordance with some examples of the present disclosure.

FIG. 8 illustrates an exemplary computing device that may be specifically configured to perform one or more of the processes described herein.

### DESCRIPTION OF EMBODIMENTS

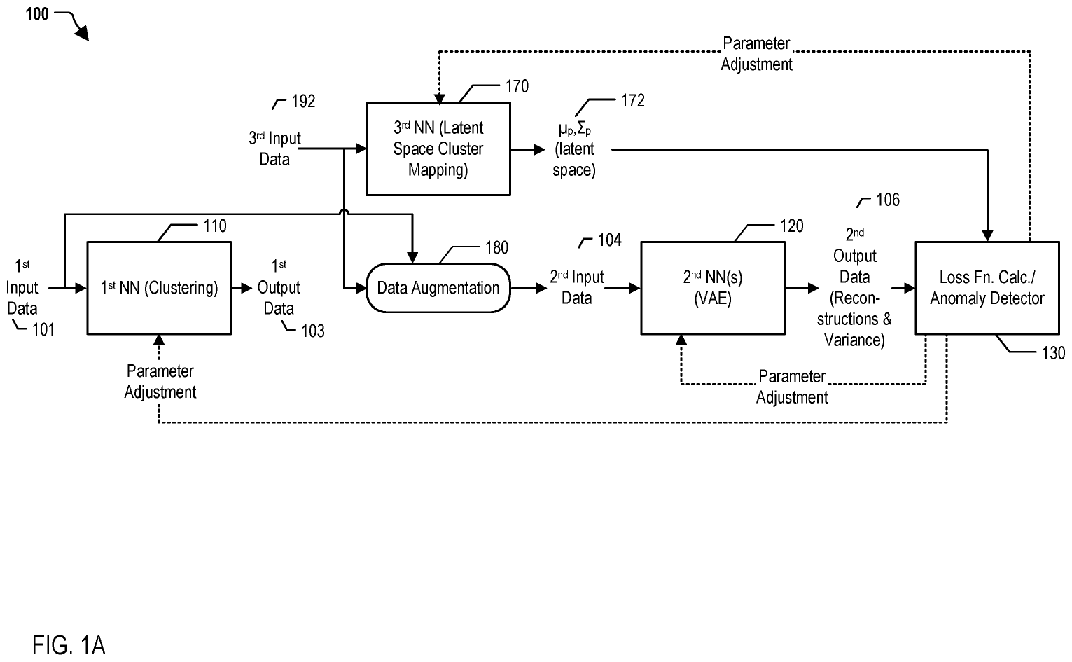

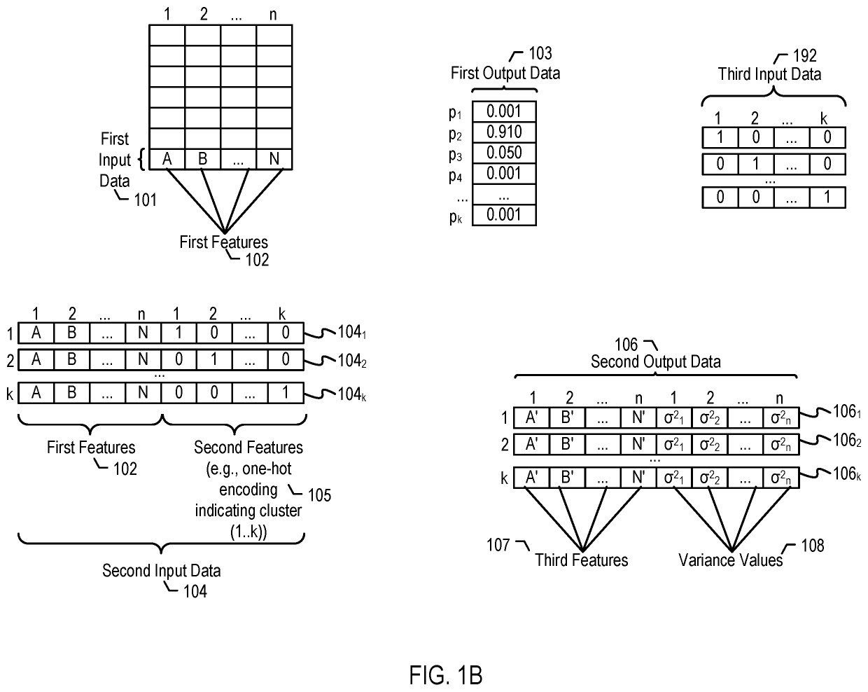

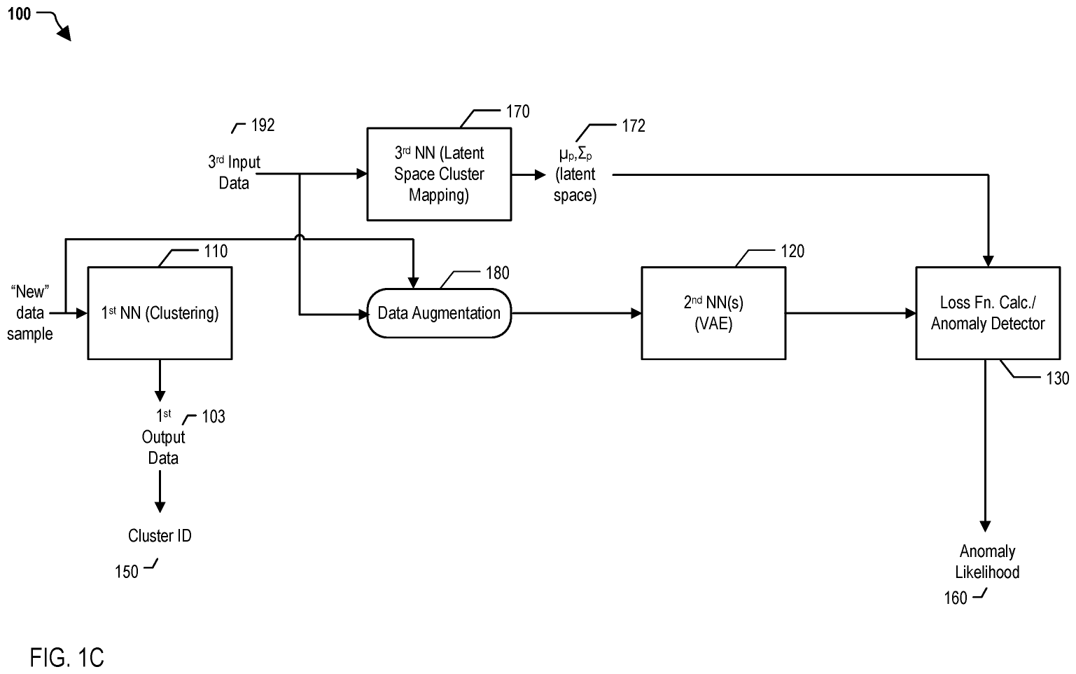

Example methods, apparatus, and products for anomaly detection and filtering of time-series data in accordance with embodiments of the present disclosure are described with reference to the accompanying drawings, beginning with FIG. 1A. Referring to FIGS. 1A, 1B, and 1C, a particular illustrative example of a system 100 is shown. The system 100, or portions thereof, may be implemented using (e.g., executed by) one or more computing devices, such as laptop computers, desktop computers, mobile devices, servers, and Internet of Things devices and other devices utilizing embedded processors and firmware or operating systems, etc. In the illustrated example, the system 100 includes a first neural network 110, second neural network(s) 120, a third neural network 170, and a loss function calculator and anomaly detector 130 (hereinafter referred to as “calculator/detector”). As denoted in FIG. 1A and as further described herein, the first neural network 110 may perform clustering, the second neural network(s) 120 may include a variational autoencoder (VAE), and the third neural network 170 may perform a latent space cluster mapping operation.

It is to be understood that operations described herein as being performed by the first neural network 110, the second neural network(s) 120, the third neural network 170, or the calculator/detector 130 may be performed by a device executing software configured to execute the calculator/detector 130 and to train and/or evaluate the neural networks 110, 120, 170. The neural networks 110, 120, 170 may be represented as data structures stored in a memory, where the data structures specify nodes, links, node properties (e.g., activation function), and link properties (e.g., link weight). The neural networks 110, 120, 170 may be trained and/or evaluated on the same or on different devices, processors (e.g., central processor unit (CPU), graphics processing unit (GPU) or other type of processor), processor cores, and/or threads (e.g., hardware or software thread). Moreover, execution of certain operations associated with the first neural network 110, the second neural network(s) 120, the third neural network 170, or the calculator/detector 130 may be parallelized.

The system 100 may generally operate in two modes of operation: training mode and use mode. FIG. 1A corresponds to an example of the training mode and FIG. 1C corresponds to an example of the use mode.

Turning now to FIG. 1A, the first neural network 110 may be trained, in an unsupervised fashion, to perform clustering. For example, the first neural network 110 may receive first input data 101. The first input data 101 may be part of a larger data set and may include first features 102, as shown in FIG. 1B. The first features 102 may include continuous features (e.g., real numbers), categorical features (e.g., enumerated values, true/false values, etc.), and/or time-series data. In a particular aspect, enumerated values with more than two possibilities are converted into binary one-hot encoded data. To illustrate, if the possible values for a variable are “cat,” “dog,” or “sheep,” the variable is converted into a 3-bit value where 100 represents “cat,” 010 represents “dog,” and 001 represents “sheep.” In the illustrated example, the first features include n features having values A, B, C, . . . N, where n is an integer greater than zero.

The first neural network 110 may include an input layer, an output layer, and zero or more hidden layers. The input layer of the first neural network 110 may include n nodes, each of which receives one of the n first features 102 as input. The output layer of the first neural network 110 may include k nodes, where k is an integer greater than zero, and where each of the k nodes represents a unique cluster possibility. In a particular aspect, in response to the first input data 101 being input to the first neural network 110, the neural network 110 generates first output data 103 having k numerical values (one for each of the k output nodes), where each of the numerical values indicates a probability that the first input data 101 is part of (e.g., classified the example of FIG. 1B, the k cluster probabilities in the first output data 103 are denoted p₁ . . . pₖ, and the first output data 103 indicates that the first input data 101 is classified into cluster 2 with a probability of (p₂=0.91=91%).

A “pseudo-input” may be automatically generated and provided to the third neural network 170. In the example of FIG. 1A, such pseudo-input is denoted as third input data 192. As shown in FIG. 1B, the third input data 192 may correspond to one-hot encoding for each of the k clusters. Thus, the third neural network 170 may receive an identification of cluster(s) as input. The third neural network 170 may map the cluster(s) into region(s) of a latent feature space. For example, the third neural network 170 may output values μₚ and Σₚ, as shown at 172, where μₚ and Σₚ represent mean and variance of a distribution (e.g., a Gaussian normal distribution), respectively, and the subscript “p” is used to denote that the values will be used as priors for cluster distance measurement, as further described below. μₚ and Σₚ may be vectors having mean and variance values for each latent space feature, as further explained below. By outputting different values of μₚ and Σₚ for different input cluster identifications, the third neural network 170 may “place” clusters into different parts of latent feature space, where each of those individual clusters follows a distribution (e.g., a Gaussian normal distribution).

In a particular aspect, the second neural network(s) 120 include a variational autoencoder (VAE). The second neural network(s) 120 may receive second input data 104 as input. In a particular aspect, the second input data 104 is generated by a data augmentation process 180 based on a combination of the first input data 101 and the third input data 192. For example, the second input data 104 may include the n first features 102 and may include k second features 105, where the k second features 105 are based on the third input data 192, as shown in FIG. 1B. In the illustrated embodiment, the second features 105 correspond to one-hot encodings for each of the k clusters. That is, the second input data 104 has k entries, denoted 104.sub.1-104.sub.k in FIG. 1B. Each of the entries 104₁-104ₖ includes the same first features 102. For the first entry 104₁, the second features 105 are “10 . . . 0” (i.e., a one-hot encoding for cluster 1). For the second entry 104₂, the second features 105 are “01 . . . 0” (i.e., a one-hot encoding for cluster 2). For the kth entry 104ₖ, the second features 105 are “00 . . . 1” (i.e., a one-hot encoding cluster k). Thus, the first input data 101 is used to generate k entries in the second input data 104.

The second neural network(s) 120 generates second output data 106 based on the second input data 104. In a particular aspect, the second output data 106 includes k entries 106.sub.1-106.sub.k, each of which is generated based on the corresponding entry 104.sub.1-104.sub.k of the second input data 104. Each entry of the second output data 106 may include at least third features 107 and variance values 108 for the third features 107. Although not shown in FIG. 1, the VAE may also generate k entries of μₑ and Σₑ, which may be used to construct the actual encoding space (often denoted as “z”). As further described below, the μₑ and Σₑ values may be compared to μₚ and Σₚ output from the third neural network 170 during loss function calculation and anomaly detection. Each of the third features is a VAE “reconstruction” of a corresponding one of the first features 102. In the illustrated embodiment, the reconstructions of features A . . . N are represented as A′ . . . N′ having associated variance values σ²₁ . . . σ²ₙ.

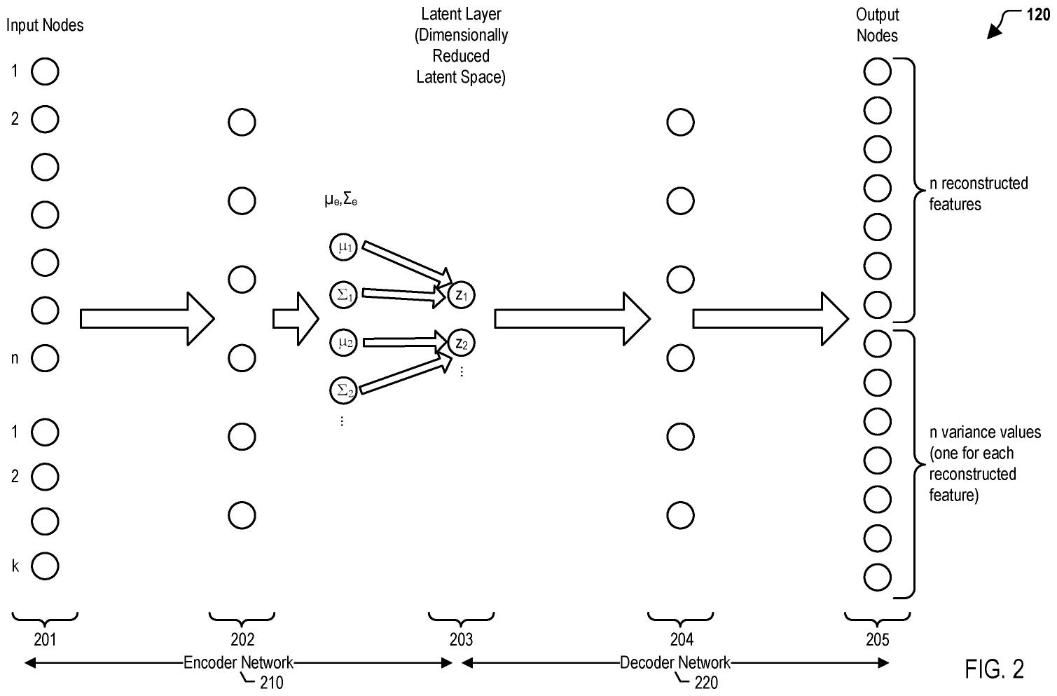

Referring to FIG. 2, the second neural network(s) 120 may include an encoder network 210 and a decoder network 220. The encoder network 210 may include an input layer 201 including an input node for each of the n first features 102 and an input node for each of the k second features 105. The encoder network 210 may also include one or more hidden layers 202 that have progressively fewer nodes. A “latent” layer 203 serves as an output layer of the encoder network 210 and an input layer of the decoder network 220. The latent layer 203 corresponds to a dimensionally reduced latent space. The latent space is said to be “dimensionally reduced’ because there are fewer nodes in the latent layer 203 than there are in the input layer 201. The input layer 201 includes (n+k) nodes, and in some aspects the latent layer 203 includes no more than half as many nodes, i.e., no more than (n+k)/2 nodes. By constraining the latent layer 203 to fewer nodes than the input layer, the encoder network 210 is forced to represent input data (e.g., the second input data 104) in “compressed” fashion. Thus, the encoder network 210 is configured to encode data from a feature space to the dimensionally reduced latent space. In a particular aspect, the encoder network 210 generates values μₑ, Σₑ, which are data vectors having mean and variance values for each of the latent space features. The resulting distribution is sampled to generate the values (denoted “z”) in the “latent” layer 203. The “e” subscript is used here to indicate that the values are generated by the encoder network 210 of the VAE. The latent layer 203 may therefore represent cluster identification and latent space location along with the input features in a “compressed” fashion. Because each of the clusters has its own Gaussian distribution, the VAE may considered a Gaussian Mixture Model (GMM) VAE.

The decoder network 220 may approximately reverse the process performed by the encoder network 210 with respect to the n features. Thus, the decoder network 220 may include one or more hidden layers 204 and an output layer 205. The output layer 205 outputs a reconstruction of each of the n input features and a variance (σ₂) value for each of the reconstructed features. Therefore, the output layer 205 includes n+n=2n nodes.

Returning to FIG. 1A, the calculator/detector 130 calculates a loss (e.g., calculate the value of a loss function) for each entry 106₁-106ₖ of the second output data 106, and calculates an aggregate loss based on the per-entry losses. Different loss functions may be used depending on the type of data that is present in the first features 102.

In a particular aspect, the reconstruction loss function L_{R_confeature} for a continuous feature is represented by Gaussian loss in accordance with Equation 1:

$${L}_{R \_ confeature} = ln ( \frac{1}{\sqrt{2 \prod {σ}^{2}}} {e}^{- \frac{{( {x}^{′} - x )}^{2}}{2 {σ}^{2}}} ) , \qquad Equation 1$$

Where In is the natural logarithm function, σ² is variance, x′ is output/reconstruction value, and x′ is input value.

To illustrate, if the feature A of FIG. 1B, which corresponds to reconstruction output A′ and variance σ²₁, is a continuous feature, then its reconstruction loss function L_{R}(A) is shown by Equation 2:

$${L}_{R \_ confeature} ( A ) = ln ( \frac{1}{\sqrt{2 \prod {σ}^{2}}} {e}^{- \frac{{( {A}^{′} - A )}^{2}}{2 {σ}^{2}}} ) , \qquad Equation 2$$

In a particular aspect, the reconstruction loss function L_{R_catfeature} for a binary categorical feature is represented by binomial loss in accordance with Equation 3ₜᵣₑₑ:

L_{R_catfeature}=xtrue ln x′+(1−xtrue)ln(1−x′), Equation 3

where ln is the natural logarithm function, xtrue is one if the value of the feature is true, xtrue is zero if the value of the feature is false, and x′ is the output/reconstruction value (which will be a number between zero and one). It will be appreciated that Equation 3 corresponds to the natural logarithm of the Bernoulli probability of x′ given xtrue, which can also be written as ln P(x′|xtrue).

As an example, if the feature N of FIG. 1B, which corresponds to reconstruction output N′, is a categorical feature, then its loss function L_{R}(N) is shown by Equation 4 (variances may not be computed for categorical features because they are distributed by a binomial distribution rather than a Gaussian distribution):

L_{R_catfeature}(N)=Nₜᵣᵤₑ ln N′+(1−Nₜᵣᵤₑ)ln(1−N′) Equation 4

The total reconstruction loss L_{R} for an entry may be a sum of each of the per-feature losses determined based on Equation 1 for continuous features and based on Equation 3 for categorical features:

L_{R}=ΣL_{R_catfeature}+ΣL_{R_catfeature} Equation 5

It is noted that Equations 1-5 deal with reconstruction loss. However, as the system 100 of FIG. 1 performs combined clustering and anomaly detection, loss function determination for an entry should also consider distance from clusters. In a particular aspect, cluster distance is incorporated into loss calculation using two Kullback-Leibler (KL) divergences.

The first KL divergence, KL₁, is represented by Equation 6 below and represents the deviation of μₚ, Σₚ from μₑ, Σₑ:

KL₁=KL(μₑ,Σₑ∥μₚ,Σₚ), Equation 6

where μₑ, Σₑ are the clustering parameters generated at the VAE (i.e., the second neural network(s) 120) and μₚ, Σₚ are the values shown at 172 being output by the latent space cluster mapping network (i.e., the third neural network 170).

The second KL divergence, KL₂, is based on the deviation of a uniform distribution from the cluster probabilities being output by the latent space cluster mapping network (i.e., the third neural network 170). KL₂ is represented by Equation 7 below:

KL₂=KL(P∥P_{Uniform}), Equation 7

where P is the cluster probability vector represented by the first output data 103.

The calculator/detector 130 may determine an aggregate loss L for each training sample (e.g., the first input data 101) in accordance with Equation 8 below:

L=KL₂+Σₚp(k)(Lg(k)+KL₁(k)), Equation 8

where KL₂ is from Equation 7, p(k) are the cluster probabilities in the first output data 103 (which are used as weighting factors), L_{R} is from Equation 5, and KL₁ is from Equation 6. It will be appreciated that the aggregate loss L of Equation 8 is a single quantity that is based on both reconstruction loss as well as cluster distance, where the reconstruction loss function differs for different types of data.

lr=10⁻⁴(N_{data}/Nₚₐᵣₐₘₛ), Equation 9

where N_{data} is the number of features and Nₚₐᵣₐₘₛ is the number of parameters being adjusted in the system 100 (e.g., link weights, bias functions, bias values, etc. across the neural networks 110, 120, 170). In some examples, the learning rate, lr, is determined based on Equation 8 but is subjected to floor and ceiling functions so that lr is always between 5×10′ and 10⁻³.

The calculator/detector 130 may also be configured to output anomaly likelihood 160, as shown in FIG. 1C, which may be output in addition to a cluster identifier (ID) 150 that is based on the first output data 103 generated by the first neural network 110. For example, the cluster ID 150 is an identifier of the cluster having the highest value in the first output data 103. Thus, in the illustrated, example, the cluster ID 150 for the first input data 101 is an identifier of cluster 2. The anomaly likelihood 160 may indicate the likelihood that the first input data 101 corresponds to an anomaly. For example, the anomaly likelihood may be based on how well the second neural network(s) 120 (e.g., the VAE) reconstruct the input data and how similar μₑ, Σₑ are to μₚ, Σₚ. The cluster ID 150 and the anomaly likelihood 160 are further described below.

As described above, the system 100 may generally operate in two modes of operation: training mode and use mode. During operation in the training mode (FIG. 1A), training data is provided to the neural networks 110, 120, 170 to calculate loss and adjust the parameters of the neural networks 110, 120, 170. For example, input data may be separated into a training set (e.g., 90% of the data) and a testing set (e.g., 10% of the data). The training set may be passed through the system 100 of FIG. 1 during a training epoch. The trained system may then be run against the testing set to determine an average loss in the testing set. This process may then be repeated for additional epochs. If the average loss in the testing set starts exhibiting an upward trend, the learning rate (1r) may be decreased. If the average loss in the testing set no longer decreases for a threshold number of epochs (e.g., ten epochs), the training mode may conclude.

After training is completed, the system 100 enters use mode (alternatively referred to as “evaluation mode”) (FIG. 1C). While operating in the use mode, the system 100 generates cluster identifiers 150 and anomaly likelihoods 160 for non-training data, such as real-time or near-real-time data that is empirically measured. In FIG. 1C, identification of certain intermediate data structures is omitted for clarity. When a new data sample is received, the system 100 outputs a cluster ID 150 for the new data sample. The cluster ID 150 may be based on a highest value within the cluster probabilities output in the first output data 103 by the first neural network 110. The system 100 also outputs an anomaly likelihood 160 for the new data sample. The anomaly likelihood 160 (alternatively referred to as an “AnomalyScore”) may be determined based on Equation 10:

AnomalyScore=L_{R}(i)*N(μₑ|μₚ,Σₚ), Equation 10

where i is the cluster identified by the cluster ID 150, L_{R}(i) is the reconstruction loss for the i^{th} entry of the second input data (which includes the one-hot encoding for cluster i), and the second term corresponds to the Gaussian probability of μₑ given μₚ and Σₚ. The anomaly likelihood 160 indicates the likelihood that the first input data 101 corresponds to an anomaly. The anomaly likelihood 160 increases in value with reconstruction loss and when the most likely cluster for the new data sample is far away from where the new data sample was expected to be mapped.

The system 100 of FIGS. 1A-1C may thus be trained and then used to concurrently perform both clustering and anomaly detection. Training and using the system 100 may be preferable from a cost and resource-consumption standpoint as compared to using different machine learning models for clustering than for anomaly detection, where the models are trained using different techniques on different training data.

Moreover, it will be appreciated the system 100 may be applied in various technological settings. As a first illustrative non-limiting example, each of multiple machines, industrial equipment, turbines, engines, etc. may have one or more sensors. The sensors may be on-board or may be coupled to or otherwise associated with the machines. Each sensor may provide periodic empirical measurements to a network server. Measurements may include temperature, vibration, sound, movement in one or more dimensions, movement along one or more axes of rotation, etc. When a new data sample (e.g., readings from multiple sensors) is received, the new data sample may be passed through the clustering and anomaly detection system. The cluster ID 150 for the data sample may correspond to a state of operation of the machine. Some cluster IDs often lead to failure and do not otherwise occur, and such cluster IDs may be used as failure prognosticators. The anomaly likelihood 160 may also be used as a failure prognosticator. The cluster ID 150 and/or the anomaly likelihood 160 may be used to trigger operational alarms, notifications to personnel (e.g., e-mail, text message, telephone call, etc.), automatic parts shutdown (and initiation of fault-tolerance or redundancy measures), repair scheduling, etc.

As another example, the system 100 may be used to monitor for rare anomalous occurrences in situations where “normal” operations or behaviors can fall into different categories. To illustrate, the system 100 may be used to monitor for credit card fraud based on real-time or near-real-time observation of credit card transactions. In this example, clusters may represent different types of credit users. For example, a first cluster may represent people who generally use their credit cards a lot and place a large amount of money on the credit card each month, a second cluster may represent people who only use their credit card when they are out of cash, a third cluster may represent people who use their credit card very rarely, a fourth cluster may represent travelers who use their credit card a lot and in various cities/states/countries, etc. In this example, the cluster ID 150 and the anomaly likelihood 160 may be used to trigger account freezes, automated communication to the credit card holder, notifications to credit card/bank personnel, etc. By automatically determining such trained clusters during unsupervised learning (each of which can have its own Gaussian distribution), the combined clustering/anomaly detection system described herein may generate fewer false positives and fewer false negatives then a conventional VAE (which would assume all credit card users should be on a single Gaussian distribution).

In some examples, the system 100 may include a driving feature detector (not shown) that is configured to compare the feature distribution within a particular cluster to the feature distributions of other clusters and of the input data set as a whole. By doing so, the driving feature detector may identify features that most “drive” the classification of a data sample into the particular cluster. Automated alarms/operations may additionally or alternatively be set up based on examining such driving features, which in some cases may lead to faster notification of a possible anomaly than with the system 100 of FIGS. 1A-1C alone.

In particular aspects, topologies of the neural networks 110, 120, 170 may be determined prior to training the neural networks 110, 120, 170. In a first example, a neural network topology is determined based on performing principal component analysis (PCA) on an input data set. To illustrate, the PCA may indicate that although the input data set includes X features, the data can be represented with sufficient reconstructability using Y features, where X and Y are integers and Y is generally less than or equal to X/2. It will be appreciated that in this example, Y may be the number of nodes present in the latent layer 203. After determining Y, the number of hidden layers 202, 204 and the number of nodes in the hidden layers 202, 204 may be determined. For example, each of the hidden layers may progressively halve the number of nodes from X to Y.

As another example, the topology of a neural network may be determined heuristically, such as based on an upper bound. For example, the topology of the first neural network 110 may be determined by setting the value of k to an arbitrarily high number (e.g., 20, 50, 100, 500, or some other value). This value corresponds to the number of nodes in the output layer of the first neural network 110, and the number of nodes in the input layer of the first neural network 110 may be set to be the n, i.e., the number of first features 102 (though in a different example, the number of input nodes may be less than n and may be determined using a feature selection heuristic/algorithm). Once the number of input and output nodes are determined for the first neural network 110, the number of hidden layers and number of nodes in each hidden layer may be determined (e.g., heuristically).

As yet another example, a combination of PCA and hierarchical density-based spatial clustering of applications with noise (HDBSCAN) may be used to determine neural network topologies. As an illustrative non-limiting example, the input feature set may include one hundred features (i.e., n=100) and performing the PCA results in a determination that a subset of fifteen specific features (i.e., p=15) is sufficient to represent the data while maintaining at least a threshold variance (e.g., 90%). Running a HDBSCAN algorithm on the fifteen principal components results in a determination that there are eight clusters in the PCA data set. The number of clusters identified by the HDBSCAN algorithm may be adjusted by a programmable constant, such as +2, to determine a value of k. In this example, k=8+2=10. The number of input features (n=100), the number of clusters from HDB SCAN (k=10) and the number of principal components (p=15) may be used to determine neural network topologies (below, a hidden layer is assumed to have twice as many nodes as the layer it outputs to).

TABLE 1

| | |
|---|---|
| VAE | Input Layer = n input features + k clusters |
| | (one-hot encoding) = 110 nodes |
| | Encoder Hidden Layer 2 = 60 nodes |
| | Encoder Hidden Layer 1 = 30 nodes |
| | Latent Layer = p principal components = |
| | 15 nodes each for μₑ and Σₑ |
| | Decoder Hidden Layer 1 = 30 nodes |
| | Decoder Hidden Layer 2 = 60 nodes |
| | Output Layer = n reconstructed features + n |
| | variance values = 200 nodes |

TABLE 2

| | |
|---|---|
| Clustering | Input Layer = n input features = 100 nodes |
| Network | Hidden Layer 1 = 60 nodes |
| | Hidden Layer 2 = 30 nodes |
| | Output Layer = k possible clusters = 10 nodes |

TABLE 3

| | |
|---|---|
| Latent | Input Layer = k possible |
| Space | clusters = 10 nodes |
| Cluster | Output Layer = p values for μₚ + |
| Mapping | p values for Σₚ = 30 nodes Network |

In a particular example, the hidden layer topology of the clustering network and the encoder network of the VAE may be the same. To illustrate, the VAE may have the topology shown in Table 1 above and the clustering network may have the topology shown in Table 4 below.

TABLE 4

| | |
|---|---|
| Clustering | Input Layer = n input features = 100 nodes |
| Network | Hidden Layer 2 = 60 nodes |
| | Hidden Layer 1 = 30 nodes |
| | Output Layer = k possible clusters = 10 nodes |

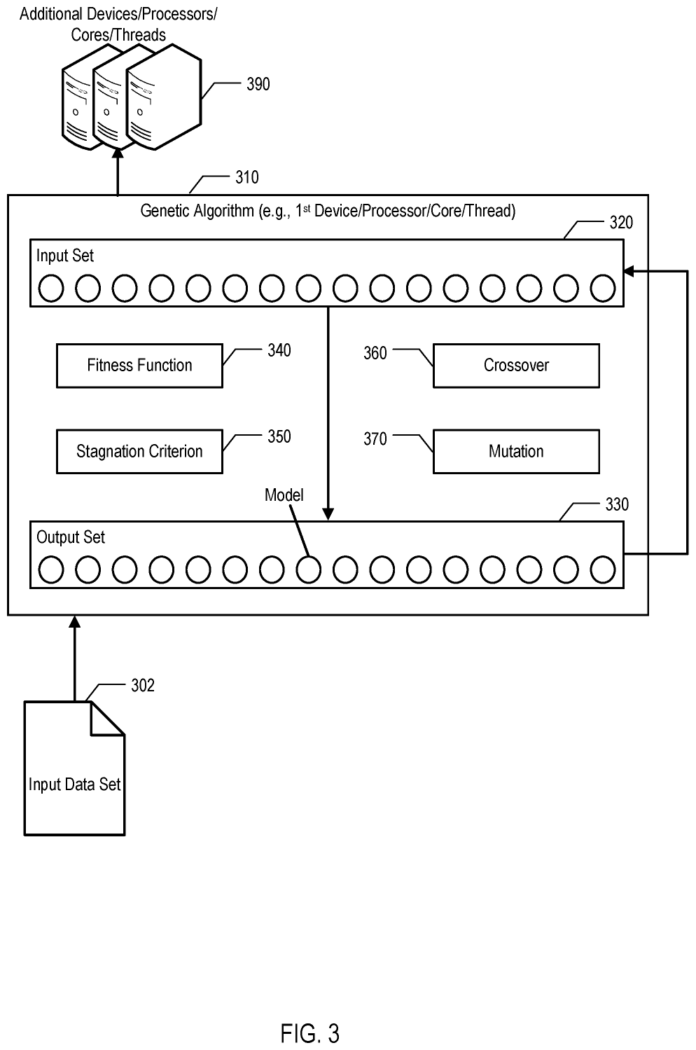

Alternatively, or in addition, referring to FIG. 3, a neural network topology may be “evolved” using a genetic algorithm 310. The genetic algorithm 310 automatically generates a neural network based on a particular data set, such as an illustrative input data set 302, and based on a recursive neuroevolutionary search process. In an illustrative example, the input data set 302 is the input data set shown in FIG. 1, which includes the first input data 101. During each iteration of the search process (also called an “epoch” or “generation” of the genetic algorithm 310), an input set (or population) 320 is “evolved’ to generate an output set (or population) 330. Each member of the input set 320 and the output set 330 is a model (e.g., a data structure) that represents a neural network. Thus, neural network topologies can be evolved using the genetic algorithm 310. The input set 320 of an initial epoch of the genetic algorithm 310 may be randomly or pseudo-randomly generated. After that, the output set 330 of one epoch may be the input set 320 of the next (non-initial) epoch, as further described herein.

The input set 320 and the output set 330 each includes a plurality of models, where each model includes data representative of a neural network. For example, each model may specify a neural network by at least a neural network topology, a series of activation functions, and connection weights. The topology of a neural network includes a configuration of nodes of the neural network and connections between such nodes. The models may also be specified to include other parameters, including but not limited to bias values/functions and aggregation functions.

In some examples, a model of a neural network is a data structure that includes node data and connection data. The node data for each node of a neural network may include at least one of an activation function, an aggregation function, or a bias (e.g., a constant bias value or a bias function). The activation function of a node may be a step function, sine function, continuous or piecewise linear function, sigmoid function, hyperbolic tangent function, or another type of mathematical function that represents a threshold at which the node is activated. The biological analog to activation of a node is the firing of a neuron. The aggregation function is a mathematical function that combines (e.g., sum, product, etc.) input signals to the node. An output of the aggregation function may be used as input to the activation function. The bias is a constant value or function that is used by the aggregation function and/or the activation function to make the node more or less likely to be activated. The connection data for each connection in a neural network includes at least one of a node pair or a connection weight. For example, if a neural network includes a connection from node N1 to node N2, then the connection data for that connection may include the node pair <N1, N2>. The connection weight is a numerical quantity that influences if and/or how the output of N1 is modified before being input at N2. In the example of a recurrent neural network, a node may have a connection to itself (e.g., the connection data may include the node pair <N1, N1>).

The genetic algorithm 310 includes or is otherwise associated with a fitness function 340, a stagnation criterion 350, a crossover operation 360, and a mutation operation 370. The fitness function 340 is an objective function that can be used to compare the models of the input set 320. In some examples, the fitness function 340 is based on a frequency and/or magnitude of errors produced by testing a model on the input data set 302. As a simple example, assume the input data set 302 includes ten rows, that the input data set 302 includes two columns denoted A and B, and that the models illustrated in FIG. 3 represent neural networks that output a predicted value of B given an input value of A. In this example, testing a model may include inputting each of the ten values of A from the input data set 302, comparing the predicted values of B to the corresponding actual values of B from the input data set 302, and determining if and/or by how much the two predicted and actual values of B differ. To illustrate, if a particular neural network correctly predicted the value of B for nine of the ten rows, then a relatively simple fitness function 340 may assign the corresponding model a fitness value of 9/10=0.9. It is to be understood that the previous example is for illustration only and is not to be considered limiting. In some aspects, the fitness function 340 may be based on factors unrelated to error frequency or error rate, such as number of input nodes, node layers, hidden layers, connections, computational complexity, etc.

In a particular aspect, fitness evaluation of models may be performed in parallel. To illustrate, the illustrated system may include additional devices, processors, cores, and/or threads 390 to those that execute the genetic algorithm 310. These additional devices, processors, cores, and/or threads 390 may test model fitness in parallel based on the input data set 302 and may provide the resulting fitness values to the genetic algorithm 310.

In a particular aspect, the genetic algorithm 310 may be configured to perform speciation. For example, the genetic algorithm 310 may be configured to cluster the models of the input set 320 into species based on “genetic distance” between the models. Because each model represents a neural network, the genetic distance between two models may be based on differences in nodes, activation functions, aggregation functions, connections, connection weights, etc. of the two models. In an illustrative example, the genetic algorithm 310 may be configured to serialize a model into a string, such as a normalized vector. In this example, the genetic distance between models may be represented by a binned hamming distance between the normalized vectors, where each bin represents a subrange of possible values.

Because the genetic algorithm 310 is configured to mimic biological evolution and principles of natural selection, it may be possible for a species of models to become “extinct.” The stagnation criterion 350 may be used to determine when a species should become extinct, as further described below. The crossover operation 360 and the mutation operation 370 may be highly stochastic under certain constraints and a defined set of probabilities optimized for model building, which may produce reproduction operations that can be used to generate the output set 330, or at least a portion thereof, from the input set 320. Crossover and mutation are further described below.

Operation of the illustrated system is now described. It is to be understood, however, that in alternative implementations certain operations may be performed in a different order than described. Moreover, operations described as sequential may instead be performed at least partially concurrently, and operations described as being performed at least partially concurrently may instead be performed sequentially.

During a configuration stage of operation, a user may specify the input data set 302 or data sources from which the input data set 302 is determined. The user may also specify a goal for the genetic algorithm 310. For example, if the genetic algorithm 310 is being used to determine a topology of the first neural network 110, the user may provide the value of k, which represents the total number of possible clusters. The system may then constrain models processed by the genetic algorithm to those that include k output nodes. Alternatively, or in addition, the user may provide input indicating whether all of the features in the input data set 302 (e.g., the first features 102) are to be used by the genetic algorithm 310 or only a subset are to be used, and this impacts the number of input nodes in the models.

In some examples, the genetic algorithm 310 is permitted to generate and evolve models having different numbers of output nodes and input nodes. The models may be tested to determine whether their topologies are conducive to clustering the input data set 302 (e.g., whether the resulting clusters are sufficiently dense, separable, etc.). In a particular aspect, a fitness function may be based on the loss function described with reference to FIG. 1. For example, for a given latent space size, the loss function can be used as the fitness function and the genetic algorithm 310 may be used to determine hidden layer topologies. Alternatively, the loss function may be supplemented to include a penalty that encourages small latent sizes, and the genetic algorithm 310 may be used to determine the latent space size as well.

Thus, in particular implementations, the user can configure various aspects of the models that are to be generated/evolved by the genetic algorithm 310. Configuration input may indicate a particular data field of the data set that is to be included in the model or a particular data field of the data set that is to be omitted from the model, may constrain allowed model topologies (e.g., to include no more than a specified number of input nodes output nodes, no more than a specified number of hidden layers, no recurrent loops, etc.).

Further, in particular implementations, the user can configure aspects of the genetic algorithm 310, such as via input to graphical user interfaces (GUIs). For example, the user may provide input to limit a number of epochs that will be executed by the genetic algorithm 310. Alternatively, the user may specify a time limit indicating an amount of time that the genetic algorithm 310 has to execute before outputting a final output model, and the genetic algorithm 310 may determine a number of epochs that will be executed based on the specified time limit. To illustrate, an initial epoch of the genetic algorithm 310 may be timed (e.g., using a hardware or software timer at the computing device executing the genetic algorithm 310), and a total number of epochs that are to be executed within the specified time limit may be determined accordingly. As another example, the user may constrain a number of models evaluated in each epoch, for example by constraining the size of the input set 320 and/or the output set 330.

After configuration operations are performed, the genetic algorithm 310 may begin execution based on the input data set 302. Parameters of the genetic algorithm 310 may include but are not limited to, mutation parameter(s), a maximum number of epochs the genetic algorithm 310 will be executed, a threshold fitness value that results in termination of the genetic algorithm 310 even if the maximum number of generations has not been reached, whether parallelization of model testing or fitness evaluation is enabled, whether to evolve a feedforward or recurrent neural network, etc. As used herein, a “mutation parameter” affects the likelihood of a mutation operation occurring with respect to a candidate neural network, the extent of the mutation operation (e.g., how many bits, bytes, fields, characteristics, etc. change due to the mutation operation), and/or the type of the mutation operation (e.g., whether the mutation changes a node characteristic, a link characteristic, etc.). In some examples, the genetic algorithm 310 may utilize a single mutation parameter or set of mutation parameters for all models. In such examples, the mutation parameter may impact how often, how much, and/or what types of mutations can happen to any model of the genetic algorithm 310. In alternative examples, the genetic algorithm 310 maintains multiple mutation parameters or sets of mutation parameters, such as for individual or groups of models or species. In particular aspects, the mutation parameter(s) affect crossover and/or mutation operations, which are further described herein.

The genetic algorithm 310 may automatically generate an initial set of models based on the input data set 302 and configuration input. Each model may be specified by at least a neural network topology, an activation function, and link weights. The neural network topology may indicate an arrangement of nodes (e.g., neurons). For example, the neural network topology may indicate a number of input nodes, a number of hidden layers, a number of nodes per hidden layer, and a number of output nodes. The neural network topology may also indicate the interconnections (e.g., axons or links) between nodes. In some aspects, layers nodes may be used instead of or in addition to single nodes. Examples of layer types include long short-term memory (LSTM) layers, gated recurrent units (GRU) layers, fully connected layers, and convolutional neural network (CNN) layers. In such examples, layer parameters may be involved instead of or in addition to node parameters. In some cases, certain layer/node types may be excluded. For example, recurrent and convolutional nodes/layers may be excluded to avoid complicating the loss function.

The initial set of models may be input into an initial epoch of the genetic algorithm 310 as the input set 320, and at the end of the initial epoch, the output set 330 generated during the initial epoch may become the input set 320 of the next epoch of the genetic algorithm 310. In some examples, the input set 320 may have a specific number of models.

For the initial epoch of the genetic algorithm 310, the topologies of the models in the input set 320 may be randomly or pseudo-randomly generated within constraints specified by any previously input configuration settings. Accordingly, the input set 320 may include models with multiple distinct topologies. For example, a first model may have a first topology, including a first number of input nodes associated with a first set of data parameters, a first number of hidden layers including a first number and arrangement of hidden nodes, one or more output nodes, and a first set of interconnections between the nodes. In this example, a second model of epoch may have a second topology, including a second number of input nodes associated with a second set of data parameters, a second number of hidden layers including a second number and arrangement of hidden nodes, one or more output nodes, and a second set of interconnections between the nodes. The first model and the second model may or may not have the same number of input nodes and/or output nodes.

The genetic algorithm 310 may automatically assign an activation function, an aggregation function, a bias, connection weights, etc. to each model of the input set 320 for the initial epoch. In some aspects, the connection weights are assigned randomly or pseudo-randomly. In some implementations, a single activation function is used for each node of a particular model. For example, a sigmoid function may be used as the activation function of each node of the particular model. The single activation function may be selected based on configuration data. For example, the configuration data may indicate that a hyperbolic tangent activation function is to be used or that a sigmoid activation function is to be used. Alternatively, the activation function may be randomly or pseudo-randomly selected from a set of allowed activation functions, and different nodes of a model may have different types of activation functions. In other implementations, the activation function assigned to each node may be randomly or pseudo-randomly selected (from the set of allowed activation functions) for each node the particular model. Aggregation functions may similarly be randomly or pseudo-randomly assigned for the models in the input set 320 of the initial epoch. Thus, the models of the input set 320 of the initial epoch may have different topologies (which may include different input nodes corresponding to different input data fields if the data set includes many data fields) and different connection weights. Further, the models of the input set 320 of the initial epoch may include nodes having different activation functions, aggregation functions, and/or bias values/functions.

Each model of the input set 320 may be tested based on the input data set 302 to determine model fitness. For example, the input data set 302 may be provided as input data to each model, which processes the input data set (according to the network topology, connection weights, activation function, etc., of the respective model) to generate output data. The output data of each model may be evaluated using the fitness function 340 to determine how well the model modeled the input data set 302 (i.e., how conducive each model is to clustering the input data). In some examples, fitness of a model based at least in part on reliability of the model, performance of the model, complexity (or sparsity) of the model, size of the latent space, or a combination thereof.

In some examples, the genetic algorithm 310 may employ speciation. In a particular aspect, a species ID of each of the models may be set to a value corresponding to the species that the model has been clustered into. Next, a species fitness may be determined for each of the species. The species fitness of a species may be a function of the fitness of one or more of the individual models in the species. As a simple illustrative example, the species fitness of a species may be the average of the fitness of the individual models in the species. As another example, the species fitness of a species may be equal to the fitness of the fittest or least fit individual model in the species. In alternative examples, other mathematical functions may be used to determine species fitness. The genetic algorithm 310 may maintain a data structure that tracks the fitness of each species across multiple epochs. Based on the species fitness, the genetic algorithm 310 may identify the “fittest” species, which may also be referred to as “elite species.” Different numbers of elite species may be identified in different embodiments.

In a particular aspect, the genetic algorithm 310 uses species fitness to determine if a species has become stagnant and is therefore to become extinct. As an illustrative non-limiting example, the stagnation criterion 350 may indicate that a species has become stagnant if the fitness of that species remains within a particular range (e.g., +/−5%) for a particular number (e.g., 5) epochs. If a species satisfies a stagnation criterion, the species and all underlying models may be removed from the genetic algorithm 310.

The fittest models of each “elite species” may be identified. The fittest models overall may also be identified. An “overall elite” need not be an “elite member,” e.g., may come from a non-elite species. Different numbers of “elite members” per species and “overall elites” may be identified in different embodiments.

The output set 330 of the epoch may be generated. In the illustrated example, the output set 330 includes the same number of models as the input set 320. The output set 330 may include each of the “overall elite” models and each of the “elite member” models. Propagating the “overall elite” and “elite member” models to the next epoch may preserve the “genetic traits” resulted in caused such models being assigned high fitness values.

The rest of the output set 330 may be filled out by random reproduction using the crossover operation 360 and/or the mutation operation 370. After the output set 330 is generated, the output set 330 may be provided as the input set 320 for the next epoch of the genetic algorithm 310.

During a crossover operation 360, a portion of one model is combined with a portion of another model, where the size of the respective portions may or may not be equal. When normalized vectors are used to represent neural networks, the crossover operation may include concatenating bits/bytes/fields 0 to p of one normalized vector with bits/bytes/fields p+1 to q of another normalized vectors, where p and q are integers and p+q is equal to the size of the normalized vectors. When decoded, the resulting normalized vector after the crossover operation produces a neural network that differs from each of its “parent” neural networks in terms of topology, activation function, aggregation function, bias value/function, link weight, or any combination thereof.

Thus, the crossover operation may be a random or pseudo-random operator that generates a model of the output set 330 by combining aspects of a first model of the input set 320 with aspects of one or more other models of the input set 320. For example, the crossover operation may retain a topology of hidden nodes of a first model of the input set 320 but connect input nodes of a second model of the input set to the hidden nodes. As another example, the crossover operation may retain the topology of the first model of the input set 320 but use one or more activation functions of the second model of the input set 320. In some aspects, rather than operating on models of the input set 320, the crossover operation may be performed on a model (or models) generated by mutation of one or more models of the input set 320. For example, the mutation operation may be performed on a first model of the input set 320 to generate an intermediate model and the crossover operation may be performed to combine aspects of the intermediate model with aspects of a second model of the input set 320 to generate a model of the output set 330.

During the mutation operation 370, a portion of a model is randomly modified. The frequency, extent, and/or type of mutations may be based on the mutation parameter(s) described above, which may be user-defined or randomly selected/adjusted. When normalized vector representations are used, the mutation operation may include randomly modifying the value of one or more bits/bytes/portions in a normalized vector.

The mutation operation may thus be a random or pseudo-random operator that generates or contributes to a model of the output set 330 by mutating any aspect of a model of the input set 320. For example, the mutation operation may cause the topology of a particular model of the input set to be modified by addition or omission of one or more input nodes, by addition or omission of one or more connections, by addition or omission of one or more hidden nodes, or a combination thereof. As another example, the mutation operation may cause one or more activation functions, aggregation functions, bias values/functions, and/or or connection weights to be modified. In some aspects, rather than operating on a model of the input set, the mutation operation may be performed on a model generated by the crossover operation. For example, the crossover operation may combine aspects of two models of the input set 320 to generate an intermediate model and the mutation operation may be performed on the intermediate model to generate a model of the output set 330.

The genetic algorithm 310 may continue in the manner described above through multiple epochs until a specified termination criterion, such as a time limit, a number of epochs, or a threshold fitness value (e.g., of an overall fittest model), is satisfied. When the termination criterion is satisfied, an overall fittest model of the last executed epoch may be selected and output as reflecting the topology of one of the neural networks in the system 100 of FIG. 1. The aforementioned genetic algorithm-based procedure may be used to determine the topology of zero, one, or more than one neural network in the system 100 of FIG. 1.

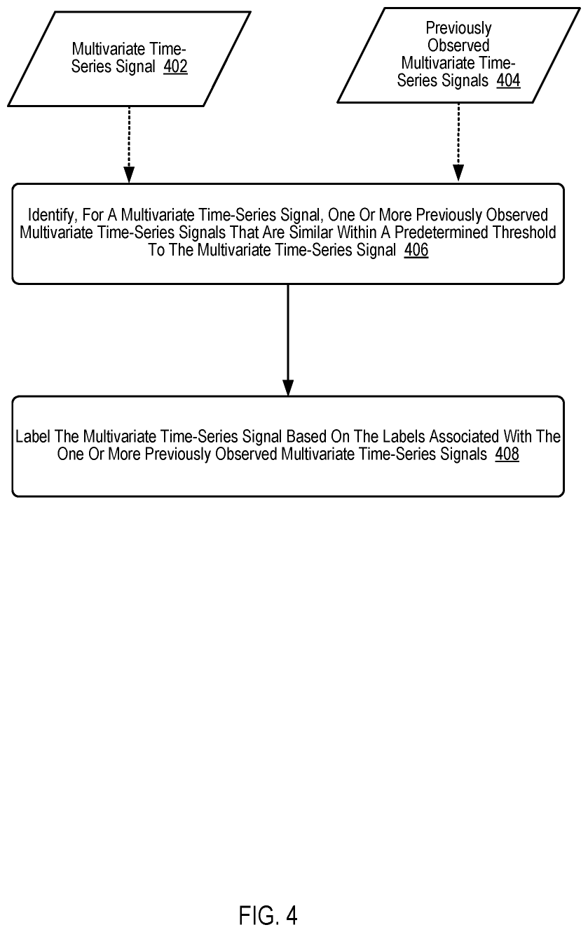

For further explanation, FIG. 4 sets forth an example method of utilizing time series fingerprints in accordance with some embodiments of the present disclosure. The example method depicted in FIG. 4 includes identifying 406, for a multivariate time-series signal 402, one or more previously observed multivariate time-series signals 404 that are similar within a predetermined threshold to the multivariate time-series signal 402. The multivariate time-series signal 402 depicted in FIG. 4 is ‘multivariate’ in the sense that the signal 402 may capture multiple variables. For example, in an embodiment where the signal is captures some operational aspects of some machine (e.g., an automotive engine) the signal may be generated using many quantifiable aspects of the machine's operation (e.g., temperature, revolutions per minute, fuel consumption). In other embodiments, the signal may capture measurable aspects of some other entity such as, for example, measurable aspects of some computing system, measurable aspects of some network of computing devices and software, and many more. Readers will appreciate that while the embodiment described herein relate to multivariate signals, in other embodiments the techniques described here may be applied to signals that relate to only a single variable.

The multivariate time-series signal 402 depicted in FIG. 4 is a ‘time-series’ signal in the sense that the signal 402 may capture the value associated with some variable at multiple points in time. For example, in an embodiment where the signal is captures some operational aspects of some machine (e.g., an automotive engine) the signal may be generated using the measured aspects of the machine's operation (e.g., temperature, revolutions per minute, fuel consumption) at multiple points in time (e.g., every second over a 60 second window, every minute over a 15 minute window). As such, the multivariate time-series signal 402 can be used to identify trends over time—rather than representing a single snapshot at a particular point in time.

The one or more previously observed multivariate time-series signals 404 depicted in FIG. 4 may be similar to the multivariate time-series signal 402, as the previously observed multivariate time-series signals 404 may be generated using the same or similar variables as the multivariate time-series signal 402. Likewise, the previously observed multivariate time-series signals 404 may be generated using values for variables that were captured at the same or similar frequency as the multivariate time-series signal 402. The one or more previously observed multivariate time-series signals 404 are ‘previously observed’ in the sense that the one or more previously observed multivariate time-series signals 404 were captured before (wholly or partially) the multivariate time-series signal 402. As such, relative to the multivariate time-series signal 402, the one or more previously observed multivariate time-series signals 404 represent an historical signal.

In the example method depicted in FIG. 4, identifying 406, for a multivariate time-series signal 402, one or more previously observed multivariate time-series signals 404 that are similar within a predetermined threshold to the multivariate time-series signal 402 may be carried out by comparing the multivariate time-series signal 402 to the one or more previously observed multivariate time-series signals 404 to determine the extent to which the multivariate time-series signal 402 is similar to each of the one or more previously observed multivariate time-series signals 404. In such an example, similarity may be measured in terms of how similar the values in each signal are, how similar the rate of change for the values in each signal are, and so on. In such an example, the predetermined threshold may be expressed in absolute terms (e.g., look for signals that are 90% similar), in relative terms (e.g., look for the 5 historical signals that are most similar to the multivariate time-series signal 402), or expressed in some other way. The comparison of signals may be carried out, for example, using techniques such as cross-correlation in which the similarity of two series is determined as a function of the displacement of one relative to the other, or in some other way. Reader will appreciate that similarity may be determined in other ways such as, for example, based on statistics-based analysis of two signals, based on similarity between the contours of two signals, based on similarity of subsequences in a time-series, or in some other way.

The example method depicted in FIG. 4 also includes labelling 408 the multivariate time-series signal 402 based on the labels associated with the one or more previously observed multivariate time-series signals 404. In the example method depicted in FIG. 4, a label that is associated with a particular multivariate time-series signal 402, 404 may be used to convey information about the particular multivariate time-series signal 402, 404. For example, a particular multivariate time-series signal 402, 404 may be labelled as an event or a non-event. In this disclosure, an ‘event’ can represent an actual recorded case of inappropriate system behavior, whereas an ‘alert’ can represent sequences in time in which a maintenance model detects abnormal behavior. As such, an event may indicate the occurrence of some condition that signals are being monitored to ultimately detect or prevent. For example, in an embodiment where the signal is captures some operational aspects of some machine (e.g., an automotive engine), an event may indicate that some operational anomaly has occurred that may be indicative of a failure, an impending failure, a need for maintenance, and so on. In this example, a non-event may indicate that the condition that signals are being monitored to detect has not occurred.

In other embodiments, a label that is associated with a particular multivariate time-series signal 402, 404 may be used to convey other information about the particular multivariate time-series signal 402, 404. For example, a label may be used to convey some score associated with the signal where the score bears a relationship to the likelihood that an event has occurred (e.g., a low score indicates that the signal relates to a non-event whereas a high score indicates that the signal relates to an event). In other embodiments, a label may be used to convey a severity level (e.g., low severity, medium severity, high severity) associated with the signal. In other embodiments, a label may be used to may be used to convey some other information about the particular multivariate time-series signal 402, 404.

Labelling 408 the multivariate time-series signal 402 based on the labels associated with the one or more previously observed multivariate time-series signals 404 may be carried out, for example, by assigning the multivariate time-series signal 402 a label that matches the labels for the one or more previously observed multivariate time-series signals 404 that are similar within a predetermined threshold to the multivariate time-series signal 402. That is, the multivariate time-series signal 402 may be labelled in a way that is consistent with the labels of the previously observed multivariate time-series signals 404 that have been identified as being the most similar to the multivariate time-series signal 402. In such an example, the label that is associated with the previously observed multivariate time-series signals 404 may have been assigned to the previously observed multivariate time-series signals 404 after investigation from a system administrator, threat evaluator, maintenance technician, or other user.

Consider the example described above in which the multivariate time-series signal 402 depicted in FIG. 4 captures some operational aspects of an automotive engine. In this example, assume that a technician evaluated the automotive engine after each occurrence of previously observed multivariate time-series signals 404 that were most similar the multivariate time-series signal 402. In such an example, assume that in 95% of those occurrences, the technician determined that there were no actual issues with the automotive engine and that the engine was operating in an acceptable manner. As such, 95% of the previously observed multivariate time-series signals 404 that were most similar the multivariate time-series signal 402 were therefore labelled as ‘non-events’ as the term is used above. In this example, labelling 408 the multivariate time-series signal 402 based on the labels associated with the one or more previously observed multivariate time-series signals 404 may therefore result in the multivariate time-series signal 402 being labelled as a ‘non-event’ given the frequency at which similar multivariate time-series signals 404 were representative of non-events. Readers will appreciate that such a label may be used for a variety of reasons such as, for example, filtering or suppressing alerts or notifications, scoring alerts or notifications, adding context to alerts or notifications, prioritizing alerts or notifications, or for a variety of other reasons.

Readers will appreciate that in an example in which w1 and w2 are two multivariate windows that are to be compared, the possible choices for distance measure between these two windows can include:
a. Euclidean distance between the multivariate alignments (this option may assume the data is normalized). If one window is smaller than the other then the smaller window may be slid over the larger window and either the average or the minimum may be taken.
b. Dynamic time warping
c. The normalized negative of the maximum of the cross-correlation

In each embodiment, if the lengths of w1 and w2 are not equal, the smaller window is gradually offset across the larger window and the distance is computed at different offsets. Moreover, for speed-up purposes, these distance computations can be done for each dimension separately and then aggregated (if the lengths are not equal, they may be aggregated for each timestep separately).

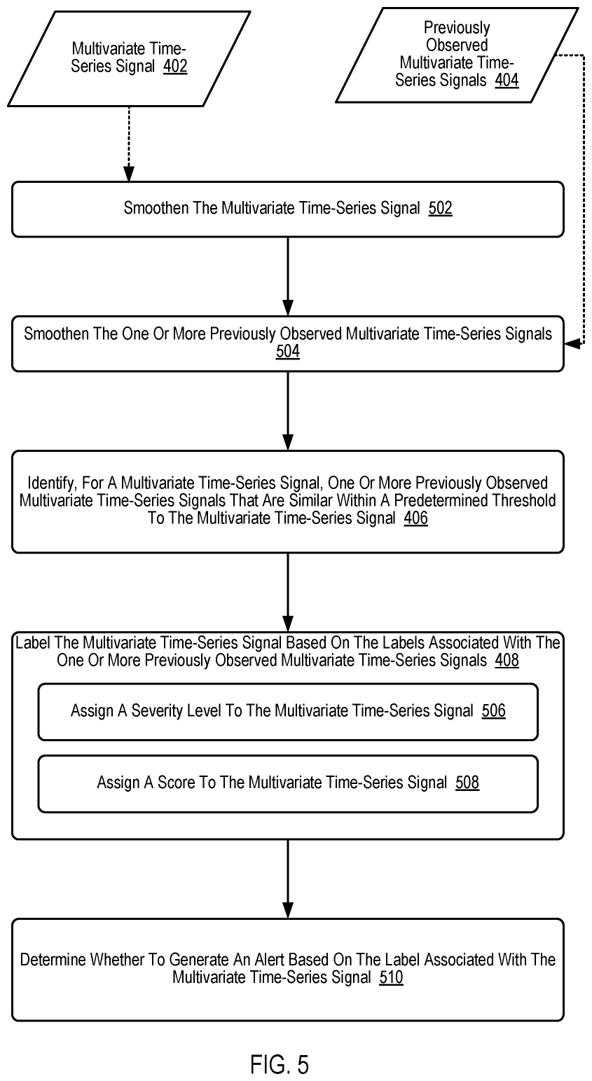

For further explanation, FIG. 5 sets forth an additional example method of utilizing time series fingerprints in accordance with some embodiments of the present disclosure. The example method depicted in FIG. 5 also includes smoothening 502 the multivariate time-series signal 402 and smoothening 504 the one or more previously observed multivariate time-series signals 404. Smoothening 502, 504 each signal 402, 404 may be carried out, for example, by creating an approximating function that attempts to capture important patterns in the data that is used to generate each signal 402, 404, while leaving out noise or other fine-scale structures/rapid phenomena. In such an example, the data points of each signal 402, 404 are modified so individual points higher than the adjacent points are reduced, points that are lower than the adjacent points are increased leading, or other techniques are used to a smoother signal. By smoothening 502, 504 each signal 402, 404, noise may be eliminated or reduced to create an improved ability to subsequently compare the smoothed version of each signal 402, 404.

In the example method depicted in FIG. 5, labelling 408 the multivariate time-series signal 402 can include assigning 506 a severity level to the multivariate time-series signal 402. The severity level that is assigned 506 to the multivariate time-series signal 402 may be determined based on how similar previously observed multivariate time-series signals 404 were labelled. Continuing with the example described above in which the multivariate time-series signal 402 captures some operational aspects of an automotive engine, if a large percentage of similar previously observed signals 404 were labelled as events, the multivariate time-series signal 402 may be assigned 506 a severity level indicating that it is likely that an event has occurred. For example, if a technician determined that 95% previously observed signals 404 that are similar to the multivariate time-series signal 402 were reflective of actual issues with the automotive engine, the multivariate time-series signal 402 may be assigned 506 a relatively high severity level. Alternatively, if a technician determined that 95% previously observed signals 404 that are similar to the multivariate time-series signal 402 occurred when the automotive engine was operating normally and without issue, the multivariate time-series signal 402 may be assigned 506 a relatively low severity level. As such, the severity level may be used to indicate the necessity of additional actions (e.g., alerts, remediation actions) in response to examining the multivariate time-series signal 402. In such an example, the severity level may be expressed using a set of possible labels (e.g., “low,” “medium,” or “high”), the severity level may be expressed using a set of possible values (e.g., a range of 1-10), or expressed in some other way.

In the example method depicted in FIG. 5, labelling 408 the multivariate time-series signal 402 can include assigning 508 a score to the multivariate time-series signal 402. The score that is assigned 508 to the multivariate time-series signal 402 may be determined based on how similar previously observed multivariate time-series signals 404 were labelled. Continuing with the example described above in which the multivariate time-series signal 402 captures some operational aspects of an automotive engine, if a large percentage of similar previously observed signals 404 were labelled as events, the multivariate time-series signal 402 may be assigned 508 a score that indicates that it is likely that an event has occurred. For example, if a technician determined that 95% previously observed signals 404 that are similar to the multivariate time-series signal 402 were reflective of actual issues with the automotive engine, the multivariate time-series signal 402 may be assigned 508 a relatively high score. Alternatively, if a technician determined that 95% previously observed signals 404 that are similar to the multivariate time-series signal 402 occurred when the automotive engine was operating normally and without issue, the multivariate time-series signal 402 may be assigned 508 a relatively low score. As such, the score may be used to indicate the necessity of additional actions (e.g., alerts, remediation actions) in response to examining the multivariate time-series signal 402. In such an example, the score may be expressed using a set of possible labels (e.g., “low,” “medium,” or “high”), the score may be expressed using a set of possible values (e.g., a range of 1-10), or expressed in some other way.

The example depicted in FIG. 5 also includes determining 510 whether to generate an alert based on the label associated with the multivariate time-series signal 402. An alert may be generated based on the label associated with the multivariate time-series signal 402, for example, if the severity level assigned to the multivariate time-series signal 402 meets a predetermined threshold, if the score assigned to the multivariate time-series signal 402 meets a predetermined threshold, or if the multivariate time-series signal 402 is otherwise associated with a label that warrants an alert. If a determination is made to generate an alert, the alert may be issued to a particular set of users, displayed via a user interface, or delivered in some other way. Such an alert can include a variety of information including, for example, the score assigned to the multivariate time-series signal 402, the severity level multivariate time-series signal 402, information associated with similar multivariate time-series signals 404, and so on.

Readers will appreciate that although the example contained in the previous paragraph describes determining 510 whether to generate an alert based on the label associated with the multivariate time-series signal 402 and ultimately generating/delivering an alert, in other embodiments other workflows may take place based on the label associated with the multivariate time-series signal 402. For example, a known remediation workflow that is specific to a particular root cause may be identified and initiated based on the label associated with the multivariate time-series signal 402. In other embodiments, other actions may be identified and initiated based on the label associated with the multivariate time-series signal 402.

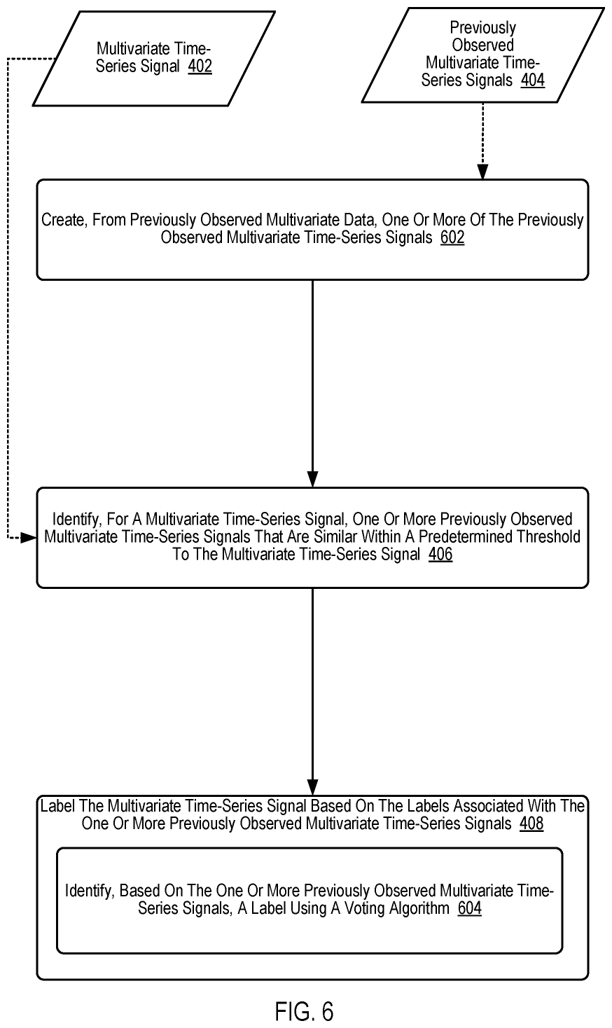

For further explanation, FIG. 6 sets forth an additional example method of utilizing time series fingerprints in accordance with some embodiments of the present disclosure. The example method depicted in FIG. 6 also includes creating 602, from previously observed multivariate data, one or more of the previously observed multivariate time-series signals 404. In the example method depicted in FIG. 6, one or more of the previously observed multivariate time-series signals 404 may be created 6012 to essentially form time slices of previously observed behavior associated with one or more systems whose operation is characterized by the previously observed multivariate time-series signals 404. Stated differently, creating 602 one or more of the previously observed multivariate time-series signals 404 from previously observed multivariate data may be carried out to create a group of candidate previously observed multivariate time-series signals 404 that may eventually be compared to the multivariate time-series signal 402, such that functions like labelling the multivariate time-series signal 402 that are described above can be performed.

In the example method depicted in FIG. 6, creating 602 one or more of the previously observed multivariate time-series signals 404 from previously observed multivariate data can be carried out in a variety of ways. For example, the previously observed multivariate data (which can include timestamps as metadata or be associated with a point-in-time in some other way) can be sliced into windows that are pre-specified to be model alerting regions based on risk scoring. Alternatively, the previously observed multivariate data can be sliced into a series of overlapping windows of the entire dataset across time, where window length and overlap offsets are parameterized or specified in some other way. In other embodiments, the previously observed multivariate data can be sliced into a series of windows that correspondence to times that are associated with a confirmed event, the previously observed multivariate data can be sliced into a series of windows that correspondence to times where alerts were generated, or the previously observed multivariate data can be sliced into a series of windows in accordance with some other heuristic. In such examples, each window of previously observed multivariate data may be used to create 602 a previously observed multivariate time-series signal 404 that tracks the values of the previously observed multivariate data over the time frame that is spanned by the window.

In the example method depicted in FIG. 6, labelling 408 the multivariate time-series signal 402 includes identifying 604, based on the one or more previously observed multivariate time-series signals 404, a label using a voting algorithm. Identifying 604 a label using a voting algorithm may be carried out, for example, by determining the label that is associated with each of the previously observed multivariate time-series signals 404 that are sufficiently similar to the multivariate time-series signal 402 and labelling 408 the multivariate time-series signal 402 with the label that is most frequently associated with the previously observed multivariate time-series signals 404 that are sufficiently similar to the multivariate time-series signal 402. In such an example, the voting algorithm may be embodied to take the label associated with each previously observed multivariate time-series signal 404 into consideration in a weighted or unweighted manner. When the voting algorithm takes the label associated with each previously observed multivariate time-series signal 404 into consideration in an unweighted manner, for example, the label that is most frequently associated with each previously observed multivariate time-series signal 404 may be used when labelling 408 the multivariate time-series signal 402. When the voting algorithm takes the label associated with each previously observed multivariate time-series signal 404 into consideration in a weighted manner, however, the label that is associated with each previously observed multivariate time-series signal 404 may be given different weights for the purposes of labelling 408 the multivariate time-series signal 402. For example, the label that is associated with a previously observed multivariate time-series signal 404 that is 90% similar to the multivariate time-series signal 402 may be weighted more heavily than the label that is associated with a previously observed multivariate time-series signal 404 that is only 70% similar to the multivariate time-series signal 402.

In some embodiments, the voting algorithm may be configured such to utilize thresholds when labelling 408 the multivariate time-series signal 402. For example, if the total average vote is above a certain threshold (i.e., revealing a relatively high occurrence rate of a particular event for the most similar previously observed multivariate time-series signals 404), then the multivariate time-series signal 402 may be labelled 408 as being a likely occurrence of the particular event. If the total average vote is not above a certain threshold (i.e., revealing a lower occurrence rate of a particular event for the most similar previously observed multivariate time-series signals 404), then the multivariate time-series signal 402 may be labelled 408 as being not being a likely occurrence of the particular event (or labelled as being ‘unknown’).

In some embodiments, the voting algorithm may also be configured to limited data in various ways. For example, if an insufficient number of similar previously observed multivariate time-series signals 404 are detected to determine that the multivariate time-series signal 402 is indicative of a non-event, the multivariate time-series signal 402 may be labelled as an event to err on the side of caution in the face of a previously unobserved deviation from normal behavior.

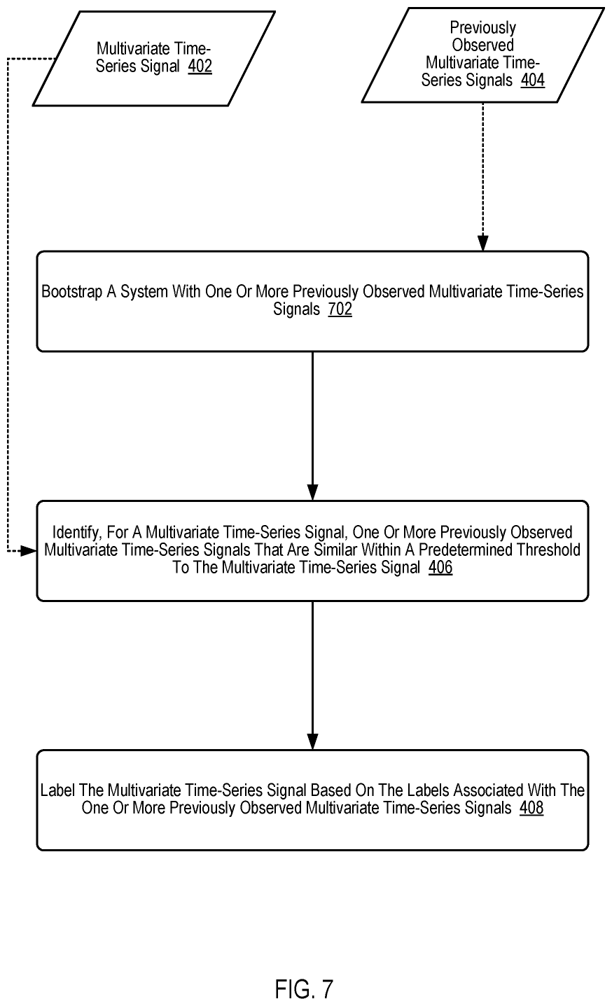

For further explanation, FIG. 7 sets forth an additional example method of utilizing time series fingerprints in accordance with some embodiments of the present disclosure. The example method depicted in FIG. 7 also includes bootstrapping 702 a system with one or more previously observed multivariate time-series signals 404. In some of the embodiments described above, the multivariate time-series signals 404 are described as being previously observed, primarily in the sense that these multivariate time-series signals 404 have been previously observed and are associated with the same system that the multivariate time-series signal 402. In some embodiments, however, a system that the multivariate time-series signal 402 may not yet have been observed and therefore a collection of previously observed multivariate time-series signals 404 may not yet exist that are associated with the system. A collection of previously observed multivariate time-series signals 404 may not yet exist that are associated with the system, for example, because the system is new, because observation of the system has only been initiated recently, because the system has been operating normally during all previous periods of observation, or for some other reason. In such an example, bootstrapping 702 a system with one or more previously observed multivariate time-series signals 404 may be appropriate to develop a baseline of multivariate time-series signals 404 that the multivariate time-series signal 402 may be compared against.

Bootstrapping 702 a system with one or more previously observed multivariate time-series signals 404 may be carried out, for example, by identifying a system that is similar to the system under observation and gathering multivariate time-series signals from the similar system. Continuing with the example described above in which the multivariate time-series signal 402 captures some operational aspects of an automotive engine, similar automotive engines may be identified and multivariate time-series signals associated with the operation of the similar automotive engines may be used initially as a baseline set of previously observed multivariate time-series signals 404. In such an example, gathering multivariate time-series signals from the similar system may be carried out through direct communication with the similar system itself, by identifying such signals in a signal repository, or in some other way.

Reader will appreciate that the fingerprints described above may be similar to (but not identical to) shapelets, particularly in how such fingerprints are used. Shapelets may transform first to extract something similar to our fingerprints, but then describes the data as distances to these shapelets, whereas the embodiments described herein take a less computationally taxing approach. In addition, when identifying similarity between two signals, embodiments described herein may not compare to the entire past history of the previously observed signals, but instead comparisons may only occur based on one or more time parameters, thereby decreasing the computational burden of such comparisons.

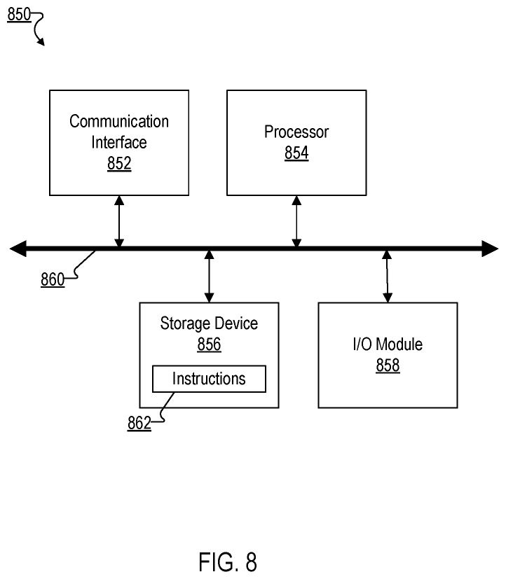

For further explanation, FIG. 8 illustrates an exemplary computing device 850 that may be specifically configured to perform one or more of the processes described herein. As shown in FIG. 8, computing device 850 may include a communication interface 852, a processor 854, a storage device 856, and an input/output (“I/O”) module 858 communicatively connected one to another via a communication infrastructure 860. While an exemplary computing device 850 is shown in FIG. 8, the components illustrated in FIG. 8 are not intended to be limiting. Additional or alternative components may be used in other embodiments. Components of computing device 850 shown in FIG. 8 will now be described in additional detail.

Communication interface 852 may be configured to communicate with one or more computing devices. Examples of communication interface 852 include, without limitation, a wired network interface (such as a network interface card), a wireless network interface (such as a wireless network interface card), a modem, an audio/video connection, and any other suitable interface.

Processor 854 generally represents any type or form of processing unit capable of processing data and/or interpreting, executing, and/or directing execution of one or more of the instructions, processes, and/or operations described herein. Processor 854 may perform operations by executing computer-executable instructions 862 (e.g., an application, software, code, and/or other executable data instance) stored in storage device 856.

Storage device 856 may include one or more data storage media, devices, or configurations and may employ any type, form, and combination of data storage media and/or device. For example, storage device 856 may include, but is not limited to, any combination of the non-volatile media and/or volatile media described herein. Electronic data, including data described herein, may be temporarily and/or permanently stored in storage device 856. For example, data representative of computer-executable instructions 862 configured to direct processor 854 to perform any of the operations described herein may be stored within storage device 856. In some examples, data may be arranged in one or more databases residing within storage device 856.

I/O module 858 may include one or more I/O modules configured to receive user input and provide user output. I/O module 858 may include any hardware, firmware, software, or combination thereof supportive of input and output capabilities. For example, I/O module 858 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 858 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 858 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 850.

Readers will appreciate that the steps described above may be performed by a solution (e.g., a computer executing computer program instructions, a service, etc. . . . ) that operates as a second-level filter. For example, all data associated with a system that is under observation may be analyzed by a first-level filter to identify anomalies and to perform other monitoring or remediation actions. In such an example, any signals that are flagged by the first-level filter may then be analyzed as described herein to prevent false positives, add context to alerts, or otherwise perform second-level filtering. In other embodiments, the steps described above may be performed by a solution (e.g., a computer executing computer program instructions, a service, etc. . . . ) that operates as a first-level filter that analyzes data associated with the system that is under observation, without any filtering occurring prior to data ingestion.

To illustrate, a first-level anomaly detector may include an autoencoder that is trained so as to reduce/minimize reconstruction error between input data to the autoencoder and output of the autoencoder where the input data represents normal behavior of an asset or system. The output data of the autoencoder, sometimes referred to as a “reconstruction” may be used to generate a residual, which in some cases can be generalized as the “difference” between the input data and the reconstruction. It is to be understood that in many cases the input data and the reconstruction are multivariate, and thus multiple residuals may be generated, such as for each of multiple sample time frames. An anomaly score may be determined based on the residual and may be used to determine when to generate an alert. In such a first-level anomaly detector, because the autoencoder is trained using data corresponding to normal behavior, the residual is expected to be significantly larger than usual when the input data to the autoencoder represents (or is leading to) an abnormal state. The described multivariate time series “fingerprint” comparison process may be used as a second-level anomaly detector, for example to detect additional anomalies that the first-level detector may miss. Alternatively, or in addition, the second-level anomaly detector may be used to suppress false positives that may have been generated by the first-level detector.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based (e.g., cloud computing) embodiment, an entirely hardware embodiment, or an embodiment combining aspects of the internet, software and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. Thus, also not shown in FIG. 1, the system 100 may be implemented using one or more computer hardware devices (which may be communicably coupled via local and/or wide-area networks) that include one or more processors, where the processor(s) execute software instructions corresponding to the various components of figures described above. Alternatively, one or more of the components of figures described above may be implemented using a hardware device, such as a field-programmable gate array (FPGA) device, an application-specific integrated circuit (ASIC) device, etc. As used herein, a “computer-readable storage medium” or “computer-readable storage device” is not a signal.

Systems and methods may be described herein with reference to screen shots, block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, spatial attention layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that the during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

Changes and modifications may be made to the disclosed embodiments without departing from the scope of the present disclosure. These and other changes or modifications are intended to be included within the scope of the present disclosure, as expressed in the following claims.

What is claimed is:

1. A method of anomaly detection and filtering of time-series data, the method comprising:
identifying, for a multivariate time-series signal, one or more previously observed multivariate time-series signals that are similar within a predetermined threshold to the multivariate time-series signal; and
labelling the multivariate time-series signal based on the labels associated with the one or more previously observed multivariate time-series signals.

2. The method of claim 1 further comprising smoothening the multivariate time-series signal.

3. The method of claim 1 further comprising smoothening the one or more previously observed multivariate time-series signals.

4. The method of claim 1 further comprising determining whether to generate an alert based on the label associated with the multivariate time-series signal.

5. The method of claim 1 wherein labelling the multivariate time-series signal includes assigning a severity level to the multivariate time-series signal.

6. The method of claim 1 wherein labelling the multivariate time-series signal includes assigning a score to the multivariate time-series signal.

7. The method of claim 1 further comprising creating, from previously observed multivariate data, one or more of the previously observed multivariate time-series signals.

8. The method of claim 1 wherein labelling the multivariate time-series signal based on the labels associated with the one or more previously observed multivariate time-series signals further comprises identifying, based on the one or more previously observed multivariate time-series signals, a label using a voting algorithm.

9. The method of claim 1 further comprising bootstrapping a system with one or more previously observed multivariate time-series signals.

10. An apparatus for anomaly detection and filtering of time-series data, the apparatus including a computer processor and a computer memory, the computer memory including computer program instructions that, when executed by the computer processor, cause the apparatus to carry out the steps of:
identifying, for a multivariate time-series signal, one or more previously observed multivariate time-series signals that are similar within a predetermined threshold to the multivariate time-series signal; and
labelling the multivariate time-series signal based on the labels associated with the one or more previously observed multivariate time-series signals.

11. The apparatus of claim 10 further comprising computer program instructions that, when executed by the computer processor, cause the apparatus to carry out the step of determining whether to generate an alert based on the label associated with the multivariate time-series signal.

12. The apparatus of claim 11 further comprising computer program instructions that, when executed by the computer processor, cause the apparatus to carry out the step of. responsive to determining to generate the alert, delivering the alert.

13. The apparatus of claim 10 further comprising computer program instructions that, when executed by the computer processor, cause the apparatus to carry out the step of creating, from previously observed multivariate data, one or more of the previously observed multivariate time-series signals.

14. The apparatus of claim 10 wherein a window for the previously observed multivariate time-series signals is equal to a window for the multivariate time-series signal.

15. The apparatus of claim 10 further comprising computer program instructions that, when executed by the computer processor, cause the apparatus to carry out the step of identifying, based on the one or more previously observed multivariate time-series signals, a label using a voting algorithm.

16. The apparatus of claim 10 further comprising computer program instructions that, when executed by the computer processor, cause the apparatus to carry out the step of bootstrapping a system with one or more previously observed multivariate time-series signals

17. A computer program product for anomaly detection and filtering of time-series data, the computer program product disposed on a non-transitory computer readable medium, the computer program product including computer program instructions that, when executed, carry out the steps of:
identifying, for a multivariate time-series signal, one or more previously observed multivariate time-series signals that are similar within a predetermined threshold to the multivariate time-series signal; and
labelling the multivariate time-series signal based on the labels associated with the one or more previously observed multivariate time-series signals.

18. The computer program product of claim 17 wherein the voting algorithm gives equal weighting to each of the one or more previously observed multivariate time-series signals.

19. The computer program product of claim 17 wherein the voting algorithm gives unequal weighting at least two or more of the previously observed multivariate time-series signals.

20. The computer program product of claim 19 wherein, for at least two or more of the previously observed multivariate time-series signals, a weighting for each previously observed multivariate time-series signal is based on a similarity between the previously observed multivariate time-series signal and the multivariate time-series signal.
